(19) United States
(12) Patent Application Publication
(10) Pub. No.: US 2005/0279296 A1
(43) Pub. Date: Dec. 22, 2005

(54) Cylinder for an internal comustion engine

(75) Inventors: Michael Willoughby Essex Coney, Swindon (GB); Andrew Robert Baker, Malvern (GB); Andrew Mark Cross, Malmesbury (GB); Richard Mark Sammut, Hurstpierpoint (GB)

Correspondence Address: BIRCH STEWART KOLASCH & BIRCH, PO BOX 747, FALLS CHURCH, VA, 22040-0747, US

(73) Assignee: INNOGY PLC, WILTSHIRE (GB)

(21) Appl. No.: 10/526,371

(22) PCT Filed: Sep. 29, 2003
(86) PCT No.: PCT/GB03/03730

§ 371 Date: Mar. 3, 2005

(30) Foreign Application Priority Data
Sep. 5, 2002 (GB) 0220685.2

(51) Int. Cl. F02F 1/16

(52) U.S. Cl. 123/41.84; 123/193.2

(57) ABSTRACT

A cylinder for an internal combustion engine. A metallic ring (6) surrounds the top of the cylinder. An insulating ring (7) is provided at the top of the cylinder between the metallic ring and cylinder wall. The axial extent of the insulating ring (7) is less than that of the metallic ring (6) and is determined so that it diverts some of the heat away from the relatively poorly cooled zone towards the top of the cylinder, but does not significantly obstruct the heat flow to surrounding cooling channels (5).

The present invention relates to a cylinder for an internal combustion engine.

In particular, the invention relates to improving the design of a cylinder where there will be high heat transfer to the liner wall. The cylinder liner will be cooled by a flow of coolant. The liner needs to have enough thickness and strength to resist the internal pressures and other mechanical forces, but the thickness is limited both by local temperatures and temperature gradients within the liner, which cause thermal stresses and reduce the fatigue life. The problem of achieving satisfactory cooling while maintaining adequate strength and fatigue life is greatest at the top of the liner because the local heat fluxes are highest and because it is difficult to place cooling channels very close to the junction between the cylinder liner and the flame-plate at the top of the cylinder.

It is common to insert a ring of suitable metal at the top of the cylinder to scrape carbon off the piston as it reaches top dead centre. This metal ring can also act as a thermal barrier, which reduces the local heat flux at the top of the cylinder liner. Further, a composite ceramic sleeve at the top of the liner is disclosed in U.S. Pat. No. 4,921,734.

GB 2,009,884 discloses an engine with a tapering metallic ring at the top end of the cylinder. The piston has a corresponding taper which prevents the piston from closely approaching the cylinder wall until it reaches the tapered ring. An insulating ring may be provided on the inner surface of the metallic ring, or an air gap may be provided between the metallic ring and cylinder.

According to the present invention a cylinder for an internal combustion engine comprises a wall generally forming the cylinder, a coolant passage to provide a flow of coolant around the wall, a metallic ring radially inward of the wall at the upper end of the cylinder, the metallic ring being capable of withstanding a higher temperature than the wall, and an insulating ring between the metallic ring and the wall extending from the top end of the metallic ring for only part of the length of the metallic ring to provide a thermal barrier to reduce the transfer of heat from the metallic ring to the wall in the vicinity of the insulating ring.

The placement of an insulating ring at the top of the metallic ring diverts some of the heat away from the relatively poorly cooled zone towards the uppermost cooling channel. However, if the insulating layer is too long, then it begins to obstruct the heat flow to the uppermost cooling channel. This significantly increases the temperature of the metallic ring, increasing the potential for thermal distortion and fatigue. It may also cause a temperature increase in the wall of the cylinder. Thus, by extending the insulating ring for only part of the length of the metallic ring this problem is overcome.

The exact extent of the insulating ring along the length of the metallic ring will vary dependent on the dimensions and operating parameters of the cylinder components. The exact extent of the ring can be determined by thermal analysis to obtain a balance between the diversion of heat from the top of the cylinder and the obstruction of heat flow to the uppermost cooling channel.

Generally, it is preferable that the insulating ring extends for less than half of the axial length of the metallic ring, and preferably along less than a quarter of the axial length of the metallic ring. Alternatively, it is preferred that the axial length of the insulating ring is less than 10% and preferably less than 5% of the cylinder bore.

For example, in certain engines, such as a medium speed (300-1000 rpm) engine with high thermal loading, the piston rings are likely to be located at a relatively large distance below the piston crown, so that the metallic ring extends to a greater degree than for an engine with lower thermal loading. Under such circumstances, the axial extent of the insulating ring will be a smaller fraction of the axial extent of the metallic ring. For engines with axially shorter metallic rings, the heat insulating ring is likely to occupy a greater proportion of the axial extent of the metallic ring.

The insulating ring may be provided by an air gap, but is more preferably a ceramic. This may be sprayed on to the metallic ring and/or liner. Alternatively, the insulating ring is a ceramic tape which is inserted into an annular gap between the metallic ring and the wall.

The cylinder may be unlined. However, preferably it is lined, in which case the wall comprises an outer portion and a liner, wherein the insulating ring is between the liner and the metallic ring. The metallic ring is preferably made of a high temperature alloy, such as an nickel alloy, e.g. Nimonic. However, less expensive materials may be used if the temperatures allow this.

The metallic ring preferably protrudes slightly into the bore of the cylinder. In this way, it will act as an anti-polishing ring in a conventional manner to remove carbon build up on the piston crown.

For applications to situations involving high heat fluxes to the liner as a whole, the coolant passage is preferably a helical path progressing around the axis of the cylinder, as this maximises the coolant velocity and hence the heat transfer. However, any suitable form of coolant passage may be used in combination with the present invention.

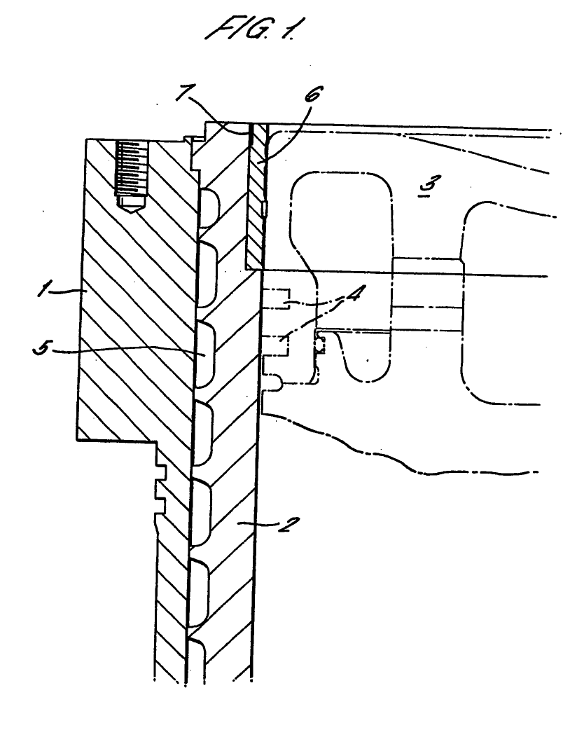

An example of a cylinder constructed in accordance with the present invention will now be described with reference to FIG. 1 which is a cross section through the upper left hand portion of the cylinder and a corresponding portion of a piston.

The cylinder 1 has a cast iron or cast steel strongback liner 2. The cylinder head (not shown) sits above the cylinder 2 in a conventional manner. A piston 3 shown partially in FIG. 1 with piston rings 4 reciprocates within the cylinder. The piston does not form part of the present invention and will not be described further here.

The cylinder liner 2 is provided with a helical coolant path which transfers coolant liquid along the length of the cylinder.

A metallic ring 6 is inserted into an annular recess at the top of the liner 2. The ring is preferably a high temperature nickel alloy such as Nimonic. The ring protrudes slightly into the bore of the cylinder to act as an anti-polishing ring. The ring can withstand the high temperatures and stresses at the top of the cylinder without risk of distortion. It will be noted from FIG. 1 that the metallic ring 6 is always positioned above the piston rings 4, even at top dead centre.

An insulating ring 7 is inserted into an annular recess in the top of the metallic ring 6 between the metallic ring and the liner 2. The insulating ring is preferably a ceramic such as Superwool paper.

In this position, the insulating ring 7 provides a thermal barrier between the top of the metallic ring 6 and the liner 2. Thus, heat which is transferred from within the cylinder to the metallic ring will be impeded from flowing through the insulating ring 7 into the very top of the liner 2. Instead, the heat is preferentially transferred to the cylinder liner below the insulating ring. This effectively directs heat into a portion of the liner 2 closer to the coolant passage 5 where it can be more readily removed by the coolant. Detailed finite element calculations show that this design reduces thermal stresses in the liner and improves the fatigue life.

In this particular example, the cylinder bore is 370 mm, the metallic ring 6 has an axial dimension of 75 mm and the insulating ring 7 has an axial dimension of 10 mm.

The method of providing an insulating layer behind the metallic ring may also be applied to situations in which there is no liner but the cylinder is instead formed by boring out the engine casting. As in the case of a cylinder liner, the insulating ring is protected from the hot combustion gases by the metallic ring, but the insulating ring in turn reduces the thermal stresses in the casting.

1. A cylinder for an internal combustion engine, the cylinder comprising a wall generally forming the cylinder, a coolant passage to provide a flow of coolant around the wall, a metallic ring radially inward of the wall at the upper end of the cylinder, the metallic ring being capable of withstanding a higher temperature than the wall, and an insulating ring between the metallic ring and the wall extending from the top end of the metallic ring for only part of the length of the metallic ring to provide a thermal barrier to reduce the transfer of heat from the metallic ring to the wall in the vicinity of the insulating ring.

2. A cylinder according to claim 1, wherein the insulating ring extends for less than half of the axial length of the metallic ring.

3. A cylinder according to claim 2, wherein the insulating ring extends for less than a quarter of the axial length of the metallic ring.

4. A cylinder according to any one of the preceding claims, wherein the axial length of the insulating ring is less than 10% of the cylinder bore.

5. A cylinder according to claim 4, wherein the axial length of the insulating ring is less than 5% of the cylinder bore.

6. A cylinder according to any preceding claim, wherein the insulating ring is ceramic.

7. A cylinder according to claim 6, wherein in the insulating ring is a ceramic tape.

8. A cylinder according to claim 6, wherein the insulating ring is sprayed onto the metallic ring and/or liner.

9. A cylinder according to claims 1 to 5, wherein the insulating ring is an air gap.

10. A cylinder according to any one of the preceding claims, wherein the wall comprises an outer portion and a liner, wherein the insulating ring is between the liner and the metallic ring.

11. A cylinder according to any of the proceeding claims, wherein the metallic ring is a high temperature alloy.

12. A cylinder according to claim 11, wherein the metallic ring is a nickel alloy.

13. A cylinder according to claim 12, wherein the metallic ring is Nimonic.

14. A cylinder according any one of the proceeding claims, wherein the metallic ring protrudes slightly into the bore of the piston to act as an anti-polishing ring on the piston.

15. An cylinder according to any one of the proceeding claims, wherein the coolant passage is helical and progresses around the axis of the cylinder.
